(19) United States
(12) Patent Application Publication
(10) Pub. No.: US 2002/0015606 A1
(43) Pub. Date: Feb. 7, 2002

(54) Print gap setting for a printing device

(76) Inventor: Gerald A. Bradfield, Waynesboro, VA (US)

Correspondence Address: Parker & DeStefano, 300 Preston Avenue Suite 300, Charlottesville, VA, 22902, US

(21) Appl. No.: 09/811,692

(22) Filed: Mar. 19, 2001

Related U.S. Application Data
(63) Continuation of application No. PCT/US00/04805, filed on Feb. 25, 2000.
(60) Provisional application No. 60/121,963, filed on Feb. 25, 1999.

(51) Int. Cl. B41J 11/20

(52) U.S. Cl. 400/55; 400/56

(57) ABSTRACT

A print head is attached to a stepper motor that moves the print head toward and away from the surface of a printing medium. During a gap setting operation, a controller controls the stepper motor to move the print head to a maximum distance away from the surface of the printing medium. A print wire actuator coil for the print wire used in the gap setting operation is then energized. The print head is then positioned over the printing medium and the controller controls the stepper motor to move the print head in towards the printing medium. When the energized print wire touches the printing medium, the print wire begins to be pushed back into the print head. As the wire is pushed back, an air gap between a yoke and a print wire armature is created. The opening of the air gap increases the amount of flux detected by a Hall sensor. When the output voltage of the Hall sensor reaches a predetermined level, the controller determines that the print wire has pressed the ribbon and printing medium against the platen. The controller then controls the stepper motor to establish the desired printing gap (e.g., by stepping back a predetermined number of steps).

This application claims priority from provisional Application No. 60/121,963, filed Feb. 25, 1999, the contents of which are incorporated herein by reference.

### BACKGROUND OF THE INVENTION

1. Field of the Invention

The present invention generally relates to an impact printer and, more particularly, to an impact printer having a print gap setting circuit for setting a print gap.

2. Description of the Prior Art

The term dot or matrix printing used herein refers to a printing system wherein characters or symbols are composed and typed by a set of small points, that is dots, formed on a printing medium by causing selected wires from among several fine wires to strike the printing medium with proper timing through an inking material such as inked or carbon ribbon. In practice, a relatively small number of wires are generally needed in dot printing in order to type the symbols. Because of its simplicity, dot printing has been widely used.

A line matrix printer is an impact printer that prints at high speeds. It forms characters out of dots that are made by impacting a ribbon against a printing medium that is backed by a hard surface in the printer. This type of printer prints dots line-by-line. In contrast, serial dot matrix printers print characters in serial succession—character-by-character—as a print head moves across a page. Impact printers are designed for high-speed printing and can be used for applications such as high-volume data processing, warehousing and distribution, multi-part forms and labels, manufacturing, industrial graphics and bar code printing.

It is known in the art to provide impact printers with so-called automatic gap setting circuits. These circuits sense the thickness of the printing medium and then automatically set the print head to the optimal gap size for printing. One such automatic gap sensing circuit is shown in U.S. Pat. No. 5,074,686. In the system disclosed in the '686 patent, the gap is determined by cocking the actuator armature and then detecting the back electromotive force (emf) generated when the armature snaps closed. This method requires that the armature be moving at a relatively high velocity so that the back emf generated by this movement can be detected by a comparator. One problem associated with this arrangement is that accurate automatic gap sensing cannot be guaranteed if the armature moves too slowly or becomes stuck and fails to move at all. In this case, a small or even no back emf will be generated.

In addition, the system of the '686 patent does not permit the static position of a print wire to be determined. This static position is of importance in impact printers. If a wire is stuck in a position with the print wire protruding towards the platen, printing cannot be allowed to proceed because the protruding wire could snag the ribbon and/or paper, causing damage to the print head and possibly to the printing mechanism. If the wire is, for example, stuck at a position which is away from the platen and not protruding out of the print head, printing can resume. This is especially true if only one wire has failed because the remaining wires (e.g., 17 wires in an 18 wire print head) can form readable characters. Most dot matrix impact printers have manual or semi-automatic adjusting mechanisms that can be used to override the automatic gap setting feature. Thus, in the situation where the print wire is stuck and is not protruding out of the print head, the user can resume printing in the manual gap adjust mode, thereby minimizing down time.

U.S. Pat. No. 5,518,323 describes a system that uses capacitance to determine armature position. In this system, an electrode is arranged near the print head armature. This electrode and the metallic armature form a variable capacitor. The capacitance value at a given distance between the electrode and armature correlates with armature position. This capacitance value is small (a few picofarads) even when the capacitance is at maximum value, due to spacing limitations in a typical print head and the use of air as a dielectric. This is an impractical arrangement for sensing print wire position because it requires high frequencies (high dv/dt) across the capacitor to obtain detectable changes in current and voltage. High frequencies of this nature are not desirable in printers because of radio frequency interference and the high costs associated with its suppression to meet FCC emission requirements. Also, this open-air variable capacitor is subject to debris (typically found in print heads due to wear of mechanical components) getting between the capacitor plates (armature and electrode) over time. This reduces the reliability of the capacitor. It is common to find iron oxide and other materials in the vicinity of the armatures as the print head wears. This can significantly alter the capacitance, especially if the debris absorbs moisture or is electrically conductive. The inventor of the present application has not seen an implementation of the arrangement disclosed the '323 patent incorporated in any printers.

### BRIEF SUMMARY OF THE INVENTION

This application describes a print gap setting circuit usable, for example, in dot matrix impact printers. The circuit uses a magnetic field sensor (such as a Hall sensor) as part of the gap setting mechanism. The Hall sensor senses the magnetic flux near an air gap that is opened as a print wire used in the gap setting operation is pushed back into a print head when the print wire contacts the printing medium. An output voltage of the Hall sensor is proportional to the magnitude of the sensed magnetic flux.

The print head is attached to a stepper motor that moves the print head toward and away from the surface of a printing medium. During a gap setting operation, a controller controls the stepper motor to move the print head to the maximum distance away from the surface of the printing medium. A print wire actuator coil for the print wire used in the gap setting operation is then energized. The print head is then positioned over the printing medium and the controller controls the stepper motor to move the print head in towards the printing medium. When the energized print wire touches the printing medium, the print wire begins to be pushed back into the print head. As the wire is pushed back, an air gap between a yoke and the print wire armature is created. The opening of the air gap increases the amount of flux detected by the Hall sensor. When the output voltage of the Hall sensor reaches a predetermined level, the controller determines that the print wire has pressed the ribbon and printing medium against the platen. Thus, the air gap opens at a steady rate as the print wire is pushed back into the print head. When the air gap reaches a predetermined size as determined by the output of a Hall sensor, the controller determines that contact with the printing medium has been made. The controller then controls the stepper motor to establish the desired printing gap (e.g., by stepping back a predetermined number of steps).

This system and method permit accurate gap adjustment and overcome many of the disadvantages of the prior art arrangements described above. For example, the gap setting circuit of the present invention does not require “abrupt” changes in reluctance (i.e., magnetic flux) to determine when a print wire contacts the printing medium. Thus, accurate gap adjusting operations can be performed regardless of the speed at which the armature moves.

The system and method of the present invention are also usable to determine the compressibility of the printing medium. The compressibility may be used to make certain adjustments (e.g., the print gap or the current used to actuate the print wires) in order to improve printing quality.

These, as well as other advantages of this invention, will be more completely understood and appreciated by careful study of the following more detailed description of an exemplary embodiment of the invention taken in conjunction with the accompanying drawings.

### BRIEF DESCRIPTION OF THE DRAWINGS

FIG. 1 is a generalized illustration of a printer system 10 in accordance with the present invention.

FIG. 2 is a schematic diagram of a print actuator for the printer system of FIG. 1.

FIG. 3 is graphically illustrates the relationship between magnetic field and coil current and air gap.

FIG. 4 is a flow diagram illustrating the steps of a calibration operation in accordance with the present invention.

FIG. 5 is a flow diagram illustrating the steps of a gap sensing operation in accordance with the present invention.

FIG. 6 is a flow diagram illustrating the steps of a static diagnostic test in accordance with the present invention.

FIGS. 7A and 7B are a schematic diagram of gap setting circuitry 700 in accordance with the present invention.

### DETAILED DESCRIPTION

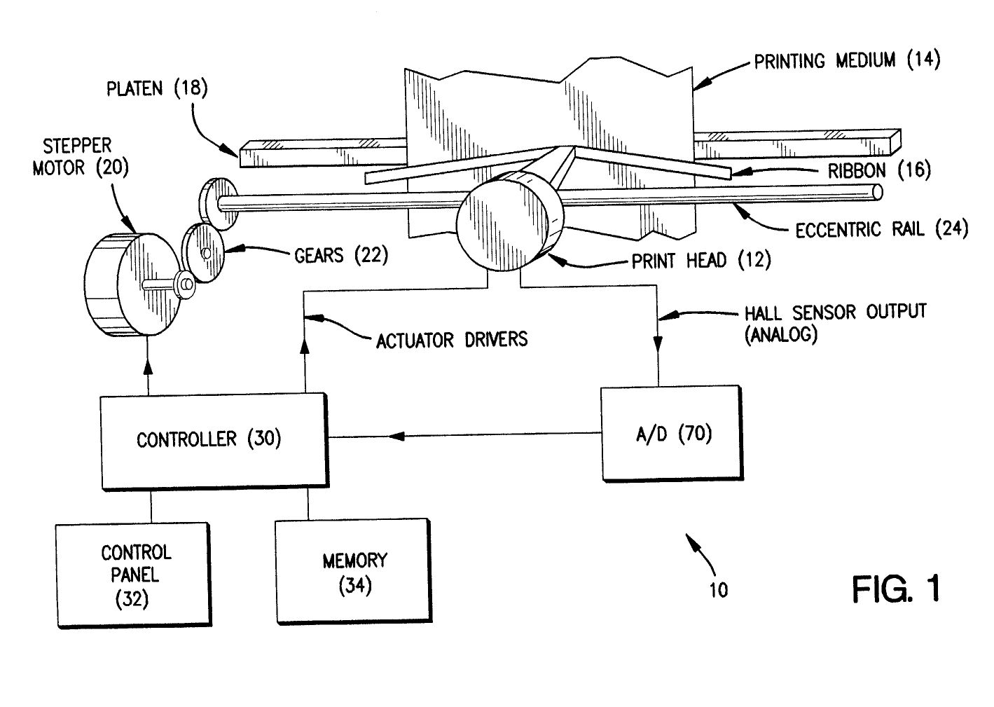

FIG. 1 is a generalized illustration of a printer system 10 in accordance with the present invention. A print head 12 includes print wires (not shown in FIG. 1) that are selectively energized in accordance with control signals from a controller 30 to effect printing on a printing medium 14 arranged between a printing ribbon 16 and a platen 18. More specifically, characters or symbols are composed and typed by a forming a set of small points on printing medium 14 by causing selected print wires from print head 12 to strike printing medium 14 with proper timing through printing ribbon 16. The overall operation of an impact print such as the impact printer generally illustrated in FIG. 1 is well known and is not described herein.

The gap between printing ribbon 16 and printing medium 14 is referred to herein as the “print gap”. To provide optimal printing quality, the size of the print gap is generally adjusted based on the thickness of printing medium 14. A ribbon support (not shown) is attached to print head 12 such that printing ribbon 16 moves and stays in contact with the print wires as the print head 12 is moved in and out by a stepper motor 20. Thus, the print gap may be set by positioning print head 12. More specifically, gap adjustment and setting are effected by stepper motor 20 that is responsive to stepper motor control signals from controller 30. Stepper motor 20 is coupled via a belt and/or gear ratio 22 to an eccentric member 24 such as a cam or the like. Of course, other suitable gap adjusting and setting structures may be used and the present invention is not limited in this respect. As stepper motor 20 positions eccentric member 24 to a desired position via belt and/or gear ratio 22 in response to control signals from controller 30, the print gap is adjusted.

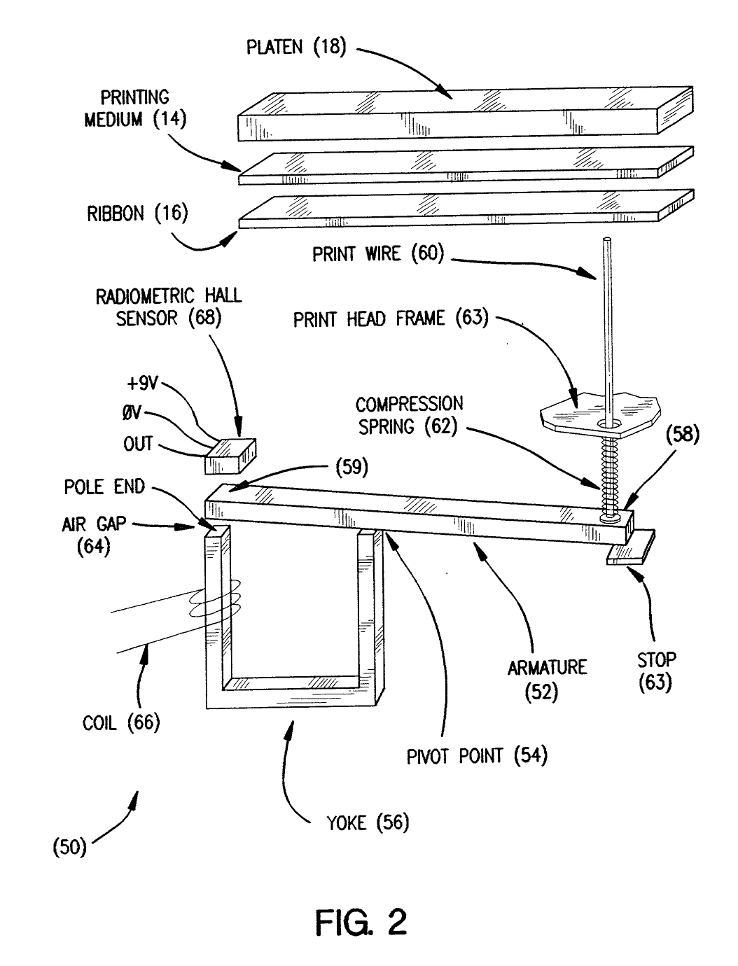

With reference to FIG. 2, print head 12 includes a print actuator 50 including an armature 52 that pivots about a pivot point 54 at a first pole end of a yoke 56. A print wire 60 is mounted near a first end 58 of armature 52. In a non-actuated state, biasing member 62 (such as a spring) biases print wire 60 away from platen 18. More particularly, as shown in FIG. 2, biasing member 62 is a spring wrapped around print wire 60. Print wire 60 includes a head (not shown) like a nail head at the point of contact with armature 52. The spring is held in place by print head frame 63 and pushes against the head of print wire 60. This pushes print wire 60 back into print head 12 and print wire 60 pushes back armature 52. If desired, print wire 60 may be welded to armature 52. Other arrangements are of course usable. A stop 63 limits the movement of print wire 60 due to the biasing of biasing member 62. Print wire 60 is actuated by applying a voltage across the terminals of print wire actuator coil 66. This causes a second end 59 of armature 52 to be magnetically attracted to a second pole end of yoke 56, which in turn causes armature 52 to pivot about pivot point 54 and move print wire 60 toward platen 18 against the resilient bias of biasing member 62. As armature 52 pivots about pivot point 54, the size of an air gap 64 between the second end 59 of armature 52 and yoke 56 varies. In the actuated state, the size of air gap 64 is a minimum (e.g., no air gap). In the non-actuated state, the size of air gap 64 is a maximum. A ratiometric Hall sensor 68 supplied with voltages +9 volts and 0 volts is positioned to sense the magnetic flux near air gap 64. As the size of air gap 64 changes, the magnitude of the magnetic flux sensed by Hall sensor 68 changes. This sensed magnetic flux is at a minimum value when the size of air gap 64 is a minimum and increases as the size of the air gap increases.

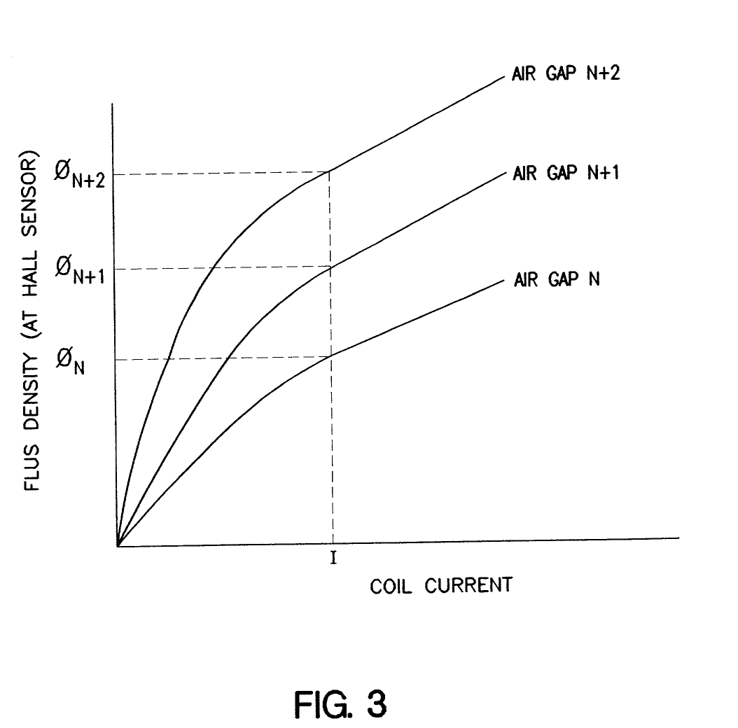

More specifically, when current is caused to flow through print wire actuator coil 66 by applying a voltage across the terminals thereof, a magnetic field is generated in yoke 56 and in air gap 64. With a constant current in print wire actuator coil 66, stray flux, not contained in air gap 64, is detected by ratiometric Hall sensor 68. The amount of stray flux detected varies in accordance with the size of air gap 64. See FIG. 3, which is graph of the magnetic field versus the coil current and air gap. As air gap 64 widens, more stray flux “escapes”, which increases the flux detected by Hall sensor 68 and results in an increase in the magnitude of the voltage output by Hall sensor 68. Since print wire 60 is in contact with armature 52, the position of armature 52 is directly related to the position of print wire 60. It has been experimentally determined that a 400 mV change can be obtained from the output of Hall sensor 68, with a 0.5 amp current flowing in coil 66, from zero air gap to 0.005 inch air gap (measured at the center of the second pole end of yoke 56). With reference to FIG. 1, the analog voltage output by Hall sensor 68 is A-to-D converted by an analog-to-digital converter 70 and supplied to controller 30.

A control panel 32 serves as a user interface for controller 30 in order to select modes of operation, to set various printer settings, on/off control, etc. A nonvolatile read/write memory 34 stores control programs for printer operation and data usable in the execution of these control programs.

The arrangements of the present invention may be utilized in various printer operations. The control programs for these printer operations are stored in memory 34 and are executed by controller 30. Controller 30 may, for example, be a microprocessor. The operations may be initiated manually using control panel 32 or automatically.

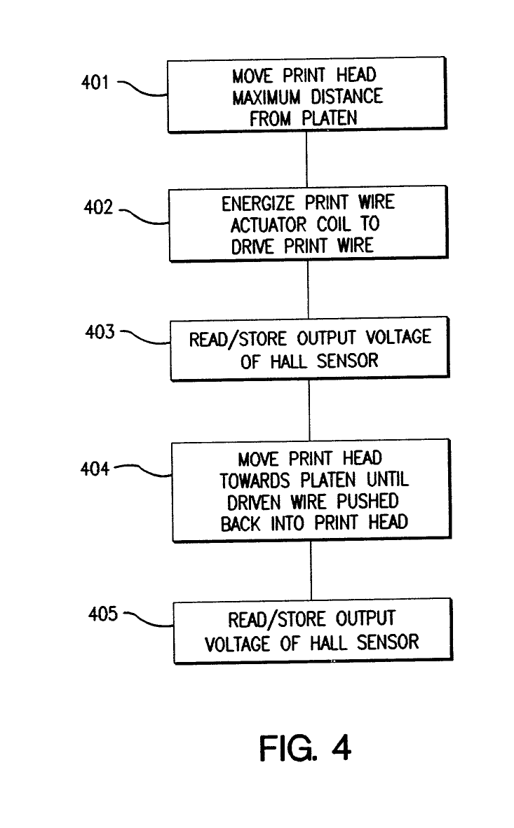

A printer calibration operation will be explained with reference to FIG. 4. At step 401, controller 30 causes print head 12 to be moved the maximum distance away from platen 18 by driving stepper motor 20 in a first (reverse) direction. As noted above, stepper motor 20 is connected through belt and/or gear ratio 22 to eccentric member 24 to move print head 12 in and out relative to platen 18 in accordance with control signals from controller 30. At step 402, print wire actuator coil 66 is energized with a current that is sufficient to drive print wire 60 to its maximum position toward platen 18. At this time, air gap 64 is closed and the tip of print wire 60 is not in contact with any surface. It is preferable that the current that drives print wire 60 to its maximum position toward platen 18 is of a magnitude sufficient to prevent the extended print wire 60 from “snapping back” or releasing due to the bias of biasing member 62 when print wire 60 makes contact with (“touches”) printing medium 14. At step 403, controller 30 reads the output voltage of Hall sensor 68 (which is A-to-D converted by analog-to-digital converter 70) and stores data indicative of this first (minimum) output voltage in memory 34. At step 404, controller 30 drives stepper motor 20 in the forward direction so that print head 12 is moved in the forward direction towards platen 18. Print head 12 is moved sufficiently forward to push print wire 60 completely back into print head 12, thereby opening armature-to-yoke air gap 64. It is preferred that the forward movement be controlled such that only the driven print wire 60 contacts printing medium 14. At step 405, controller 30 again reads the A-to-D converted output of Hall sensor 68 and stores data indicative of this second (maximum) voltage in memory 34.

The operation described with reference to FIG. 4 calibrates the gap setting circuitry. The maximum and minimum voltages, representing the extreme print wire movements, are stored in nonvolatile memory 34. In a new print head, these stored values become references for subsequent measurements such as actuator wear and stuck print wires throughout the life of the print head. These two points become the end points of a curve relating the size of air gap 64 to the voltage output from Hall sensor 68. Controller 30 is thus able to determine the actual position of print wire 60 statically or dynamically within the resolution of analog-to-digital converter 70.

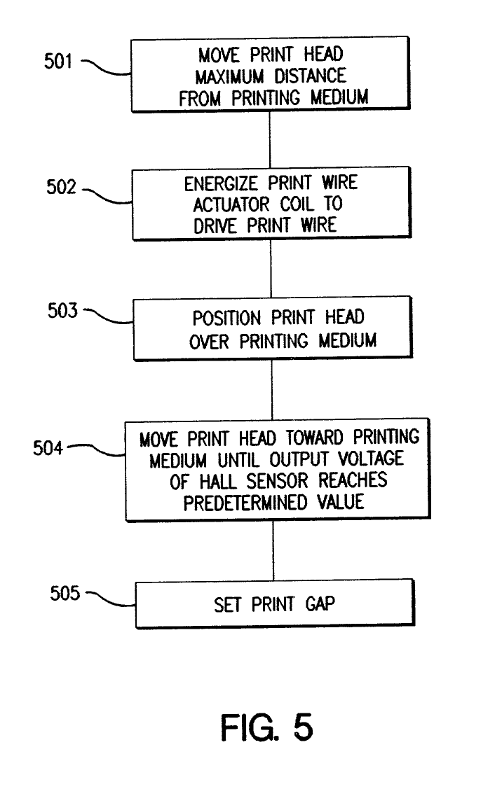

A print gap setting operation will be described with reference to FIG. 5. After the calibration operation described with respect to FIG. 4 has been performed, the position of print wire 60 can be used to detect and set the print gap in accordance with the process shown in FIG. 5. At step 501, controller 30 controls stepper motor 20 to move print head 12 back to the maximum distance away from the surface of printing medium 14. At step 502, print wire actuator coil 66 is energized with the same current used in the calibration process. At step 503, print head 12 is positioned over printing medium 14 (if not already so-positioned). At step 504, controller 30 controls stepper motor 20 to move print head 12 in towards printing medium 14 until the output voltage of Hall sensor 68 reaches a predetermined level between the maximum and minimum voltages stored in nonvolatile memory 34. At this point, controller 30 determines that print wire 60 has “touched” or made contact with printing medium 14 (i.e., pressed ribbon 16 and printing medium 14 against platen 18). At step 505, controller 30 controls stepper motor 20 to set the desired printing gap (e.g., by stepping back a predetermined number of steps from the contact point).

As discussed above, Hall sensor 68 is positioned to measure the magnetic flux in the vicinity of air gap 64 between yoke 56 and print wire armature 52. This magnetic flux is dependent on the reluctance of the electromagnet circuit comprised of armature 52, yoke 56, and air gap 64. The reluctance depends on the size of air gap 64 and the size of air gap 64 is dependent on the position of armature 52. The output voltage of Hall sensor 68 (which is indicative of the measured flux and hence reluctance) is compared with a reference voltage. This reference voltage corresponds to a reference flux (and hence a reference reluctance) and defines the point at which air gap 64 is considered to be “open” for purposes of determining when print wire 60 has made contact with printing medium 14.

As noted above, the output voltage of Hall sensor 68 is indicative of reluctance, which is itself indicative of the position of armature 52. Since Hall sensor 68 provides a measure of reluctance even when there is no reluctance change, no movement of armature 52 is necessary to generate an output voltage from Hall sensor 68. Thus, Hall sensor 68 enables a determination of the position of armature 52, not just, for example, when significant reluctance changes occur. For example, the actual position of the armature may be determined at a number of different times during a printing operation involving print wire 60. These positions of the armature may be compared with “reference” positions stored in memory 34 in order to determine whether armature movement is being limited, for example, by contaminants.

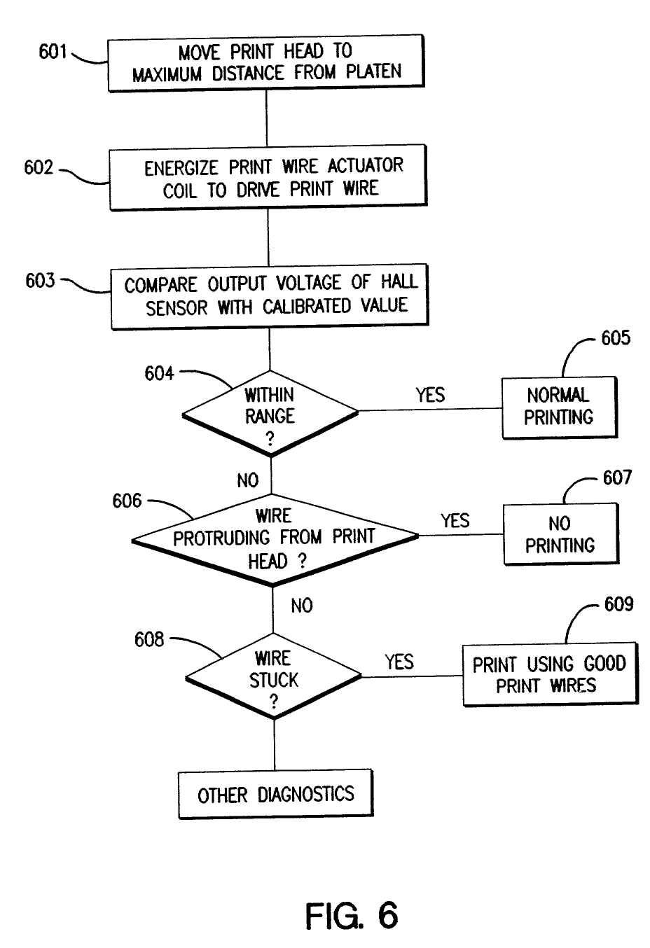

After completing the calibration process described with reference to FIG. 4, the gap setting circuitry can be used in diagnostic performance testing of print actuators during the life of the print head. One such diagnostic testing operation is described with reference to FIG. 6. In step 601, controller 30 controls stepper motor 20 to move print head 12 to its maximum distance away from platen 18. In step 602, print wire actuator coil 66 is energized with the same current used during the calibration mode. The analog-to-digitally converted output of Hall sensor 68 is then compared with the value obtained at the time of calibration at step 603. If the difference between the two values is within a certain predetermined range at step 604, printing may proceed as normal at step 605. Otherwise, one of various actions may be taken. If the output voltage of Hall sensor 68 suggests that print wire 60 is protruding from print head 12 at step 606, printing cannot proceed and the print head 12 may need to be repaired or replaced (step 607). At step 608, if the output voltage of Hall sensor 68 suggests that print wire 60 is stuck and not protruding out from print head 12, controller 30 can carry out printing operations at step 609 using the other good print actuators. As noted above, the remaining wires (e.g., 17 wires in an 18 wire print head) can form readable characters. The results of this diagnostic testing operation may, for example, be displayed on a display of control panel 32. This diagnostic testing operation could be performed when the printer is powered up or before each printing operation to minimize print wire snagging which is common in dot matrix impact printers.

The system of the present invention may also be configured to perform a dynamic diagnostic testing operation. To perform such an operation, the calibration operation described with reference to FIG. 4 may be modified to so that when print wire actuator coil 66 is energized with print head 12 at maximum distance from platen 18, controller 30 reads the A-to-D converted output of Hall sensor 68 at a plurality of predefined intervals. Controller 30 then stores in memory 34 data indicative of the print wire position during this energizing as a function of time. During a dynamic diagnostic testing operation in the field, print wire actuator coil 66 is again actuated and controller 30 again reads the A-to-D converted output of Hall sensor 68 at a plurality of predefined intervals. The print wire position as a function of time data generated during this dynamic diagnostic mode is compared with the print wire position as a function of time data generated during the calibration operation. If the differences in the data are within a predetermined range, the print wire is suitable for printing operations and printing can continue. If not, appropriate action or actions can be taken. These actions can include stopping printing and/or generating a suitable indication on control panel 32.

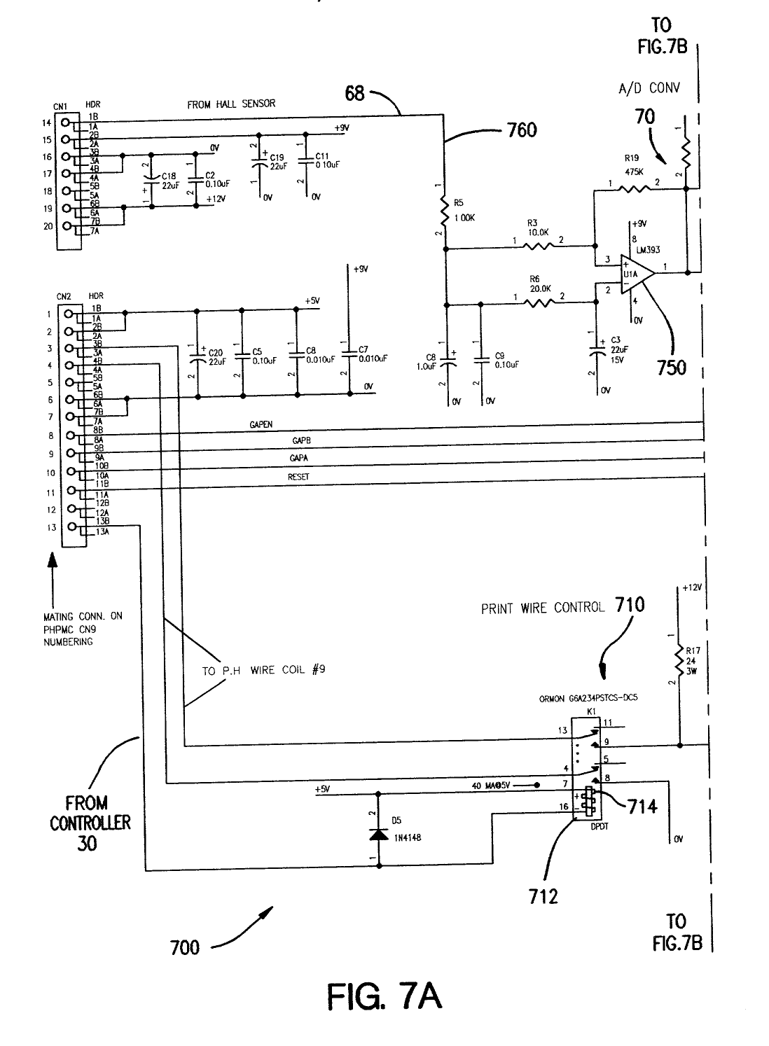

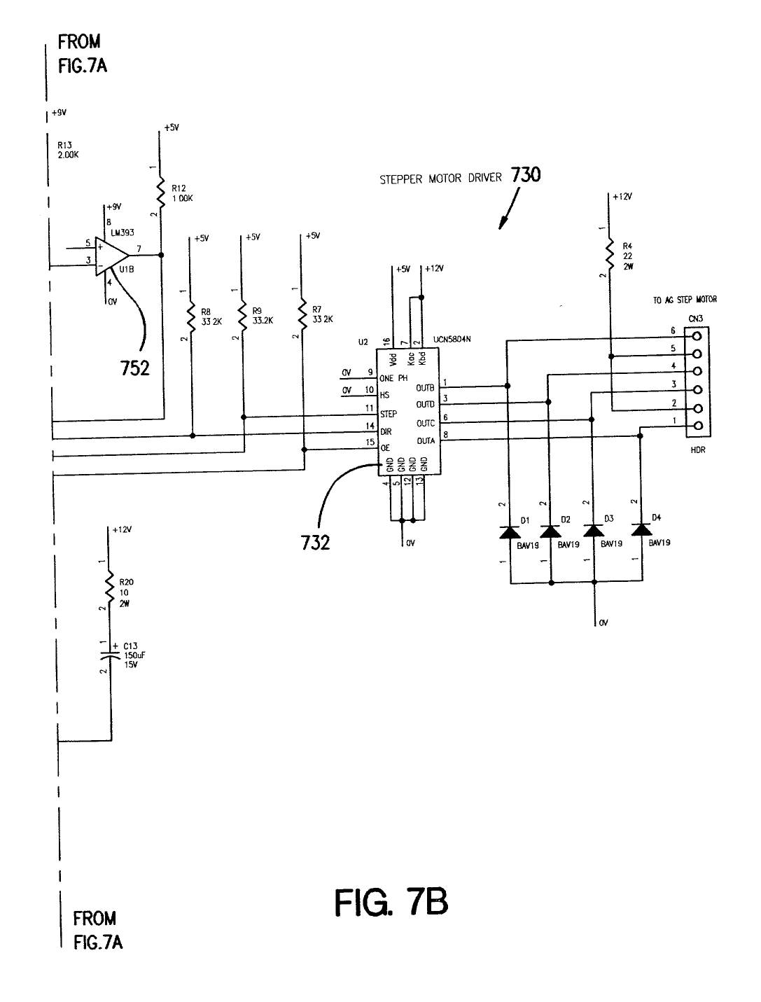

FIGS. 7A and 7B are a schematic diagram of one implementation of gap setting circuitry 700 in accordance with the present invention. Gap setting circuitry 700 includes a print wire control section 710 including a relay 712 for energizing print wire actuating coil 66 during the gap setting operations. A coil 714 is connected at a first end to a voltage source (+5 volts) and at a second end to a digital signal output by controller 30. To turn coil 714 on, the digital signal from controller 30 supplied to the second end of coil 714 is made low. When relay 712 turns on, pin 13 is connected to pin 9 and pin 4 is connected to pin 8. Thus, pin 13 of relay 712 connects the first end of print wire actuator coil 66 to resistors R17 and R20 and capacitor C13 and pin 4 of relay 712 connects the second end of print wire actuator coil 66 to ground.

When relay coil 714 is energized, a current flows through resistor R17 and momentarily flows through resistor R20 and capacitor C 13. Resistor R20 and capacitor C13 provide a “boost” to the current for a few millseconds. This boost is generated to get print wire 60 moving and to ensure that print wire 60 is not stuck (e.g., due to ink around the print wire). The initial “boosted” current may, for example, be about 1 ampere. This boosted current may decrease back to a “non-boosted” value of about, for example, 0.5 ampere after a time determined by the values of resistor R20 and capacitor C13. The “non-boosted” current is preferably large enough to prevent the extended print wire 60 from “snapping back” or releasing due to the bias of biasing member 62 when print wire 60 makes contact with (“touches”) printing medium 14.

Print wire control section 710 is connected in parallel across a print wire actuating coil that is already connected to conventional driving circuitry (not shown) for driving the print wire during normal printing operations. Thus, after the gap setting operations are completed, controller 30 opens relay 712 and the print wire to which relay 712 is connected is controlled by conventional driving circuitry to print dots during normal printing operations.

It is advantageous (although not required) that the print wire used in the gap setting operations is a relatively low-use print wire, i.e., a print wire that is generally energized less often than other print wires during normal printing operations. In other implementations, the system may be configured so that more than one print wire is usable for the gap setting operations. Thus, for example, if one of print wires for the gap setting operations becomes non-operational, the system may use one of the other suitably configured print wires. In a still further implementation, the system may be configured with a wire dedicated for the gap setting operations, i.e., a wire that is not used in normal printing operations.

It is possible to provide Hall sensors and the print wire drive circuitry of the present invention for all print wires. In this arrangement, print gaps could be determined using each wire. This would provide an indication of which print wires are wearing more than others. If certain print wires were, for example, worn back more than other print wires, the print gap could be reduced by some amount so that the receded (worn) print wires provide more effective printing.

Gap setting circuitry 700 also includes a stepper motor driver 730 for driving stepper motor 20. Stepper motor driver 730 includes a driver circuit 732 that steps stepper motor 20 one full step each time a negative edge of a square wave pulse from controller 30 is supplied to the STEP input thereof. Controller 30 controls whether stepper motor 20 is moved toward or away from platen 18 by supplying an appropriate signal to the DIR input of driver circuit 732. Controller 30 enables/disables the outputs of driver circuit 732 by supplying a signal to the OE input of driver circuit 732. For example, the outputs of driver circuit 732 may be disabled so that no current flows though the windings of stepper motor 20 during printer power-up or to save power when the printer is turned on but not printing. Outputs OUTB, OUTD, OUTC, and OUTA of driver circuit 732 are the output phases to stepper motor 20. Finally, diodes D1, D2, D3 and D4 are blocking diodes to prevent back emf from damaging the motor driven circuitry.

A-to-D converter 70 shown in FIG. 1 is also included in gap setting circuitry 700. The output of Hall sensor 68 is supplied to a comparator 750 via various resistors and capacitors. A feedback loop including resistor R19 is provided for hysteresis and an inverter 752 inverts the output of comparator 750. When a gap setting operation is performed, a voltage is applied across print wire actuator coil 66. At this time, Hall effect sensor 68 outputs a very small voltage since air gap 64 in print head 12 is closed. A certain amount of signal will be supplied to the A-to-D converter section via sensing line 760. If the circuitry of FIGS. 7A and 7B is used, sensing line 760 will be resting at approximately 50% of 9 volts, i.e., 4.5 volts, when air gap 64 in print head 12 is closed. The actual voltage will vary from one Hall sensor to another based on ambient temperature, device characteristics, etc. This voltage is left on line 760 for some period of time (e.g., about 1 to 1½ seconds) to permit stabilization. A current flows through resistor R6 until capacitor C3 is charged. Capacitors C8 and C9 provide filtering. After this stabilization time, the output of comparator 750 is at equilibrium with the inputs thereof. When the output of Hall sensor 68 changes instantaneously, the voltage at pin 2 of comparator 750 will remain stable for a short period of time. When the voltage at pin 3 of comparator 750 drops down below the voltage at pin 2 of comparator 750, the output at pin 1 of comparator 750 goes low. The feedback provided by the feedback loop including resistor R19 is relatively small and is intended to provide some hysteresis to prevent oscillations when the output switches, and to create a slight offset so that there is a potential difference between the inputs of comparator 750 so that the output of comparator 750 will be predictable.

Resistor R6 and capacitor C3 provide a self-calibrating mechanism for the A-to-D converter to take into account temperature variations or component variations. When print wire actuator coil 66 is energized, the output voltage of the Hall sensor 68 changes. Controller 30 is configured to allow the circuit to self-calibrate by waiting about 1 to 1½ seconds. When the voltages associated with resistors R6 and capacitor C3 stabilize and A-to-D converter 70 is self-calibrated, controller 30 begins the gap setting operation by pulsing stepper motor 20 to move print head 12 until print wire 60 touches printing medium 14 as determined by a change in the output of comparator 750. Stepper motor 20 may be pulsed such that print head 12 is moved at a rate of 100 steps/sec. Of course, the invention is not limited in this respect. It will be apparent that the greater the number of steps per second, the faster the gap setting operation. Inverter 752 is provided to provide the appropriate polarity back to controller 30.

A-to-D converter 70 described above is essentially a self-calibrating one-bit A-to-D converter that converts the analog output voltage of Hall sensor 68 into a digital signal. The present invention is of course not limited in this respect and multi-bit A-to-D converters may also be utilized. It is also not necessary that the A-to-D converter be self-calibrating and it is contemplated that manually calibrated A-to-D converters may also be used.

Using the system of the present invention, the compressibility of printing medium 14 can be determined. The system determines the compressibility of printing medium 14 by making a plurality of measurements as described below. Subsequent actions can be taken based on the determined compressibility of the printing medium. For example, the size of the gap may be modified and/or the magnitude of the current driving the print wire actuator coil may be modified. The process for measuring this compressibility will now be described.

The compressibility of printing medium 14 is determined by making print gap measurements at two or more different currents. Thus, a first gap measurement is made by supplying a first current (e.g., 500 milliamperes) to print wire actuator coil 66. From a predetermined print head position that ensures print head 12 is back away from printing medium 14, print head 12 is moved toward printing medium 14 until the voltage output by Hall sensor 68 exceeds a predetermined value as determined by comparator 750. That is, print head 12 is moved in toward printing medium 14 until print wire 60 touches printing medium 14. The number of steps of stepper motor 20 to move print head 12 from the predetermined print head position to the position of print head 12 when print wire 60 touches printing medium 14 is determined and stored. Print head 12 is then moved back to the predetermined print head position and the current supplied to print wire actuator coil 66 is then switched to a higher, second current (e.g., 1 ampere). Then, print head 12 is moved in toward printing medium 14 and the number of steps until the voltage output by Hall sensor 68 exceeds the predetermined value as determined by comparator 750 are counted. That is, the number of steps until print wire 60 touches printing medium 14 is counted. Because each step of stepper motor 20 moves print head 12 by a known predetermined amount, the difference in the number of steps using the first and second currents can be used to calculate how much printing medium 14 is compressed. Determining the compressibility of the printing medium allows a more optimal print gap to be set. For example, if the difference in the number of steps is small, printing medium 14 was not compressed very much (e.g., printing medium 14 is hard cardboard). In this case, no adjustments to print gap 64 and/or to the current supplied to print wire actuating coil 66 may be necessary. If the difference in the number of steps is large, printing medium 14 is relatively compressible (e.g., multi-part paper). In this case, controller 30 may execute a routine stored in memory 34 for modifying certain printing operation parameters to account for this compressibility. For example, the gap setting may be reduced relative to the gap setting for a less compressible printing medium of the same thickness. Alternatively, the print wire could be fired “harder” (i.e., fired with an increased print wire actuator coil current) relative to the firing for a less compressible printing medium of the same thickness.

Any patent and technical documents referenced above are hereby incorporated by reference into this application.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A printing device, comprising:
a print head comprising print wires;
print wire driving circuit for selectively driving one of said print wires;
a magnetic field sensor positioned in the vicinity of a variable air gap associated with the driven print wire, said magnetic field sensor outputting a signal indicative of the magnitude of the sensed magnetic field; and
a control circuit responsive to the signal output by said magnetic field sensor.

2. The printing device according to claim 1, wherein said control circuit is responsive to the signal output by said magnetic field sensor for setting a print gap of said printing device.

3. The printing device according to claim 1, wherein said control circuit is responsive to the signal output by said magnetic field sensor for determining a position of the driven print wire.

4. The printing device according to claim 1, wherein said control circuit is responsive to the signal output by said magnetic field sensor for determining a compressibility of a printing medium.

5. The printing device according to claim 4, wherein said control-circuit is configured to use the determined compressibility for setting a print gap of said printing device.

6. The printing device according to claim 4, wherein said control circuit is configured to use the determined compressibility for setting a current for driving print wires in said print head during printing operations.

7. The printing device according to claim 1, wherein said control circuit is responsive to the signal output by said magnetic field sensor for determining a position of said driven print wire as a function of time.

8. The printing device according to claim 7, further comprising:
a memory for storing data indicative of the position of said driven print wire as a function of time.

9. The printing device according to claim 8, wherein said control circuit is configured to periodically determine the position of said driven wire as a function of time and to compare data from these periodic determinations with the data stored in said memory.

10. The printing device according to claim 9, further comprising:
a control panel for communicating data indicative of the results of the comparison.

11. The printing device according to claim 9, wherein said control circuit is configured to control said printing device based on the results of the comparison.

12. The printing device according to claim 1, wherein said magnetic field sensor comprises a Hall sensor.

13. The printing device according to claim 12, wherein the Hall sensor is a ratiometric Hall sensor.

14. The printing device according to claim 1, wherein the driven print wire is in contact with a first end of a print wire armature that is arranged to pivot around a first pole end of a yoke and the air gap associated with the driven print wire is an air gap between a second end of said print wire armature and a second pole end of said yoke.

15. The printing device according to claim 14, wherein said print wire driving circuitry comprises a coil wrapped around a portion of said yoke and relay circuitry for selectively supplying a voltage to terminals of said coil.

16. The printing device according to claim 1, further comprising:
an analog-to-digital converter for converting the signal indicative of the magnitude of the sensed magnetic field to a digital signal and outputting the digital signal to said circuit.

17. The printing device according to claim 16, wherein said analog-to-digital converter comprises a one-bit analog-to-digital converter.

18. The printing device according to claim 16, wherein said analog-to-digital converter is self-calibrating.

19. The printing device according to claim 1, further comprising:
a biasing member for biasing said print wire in a direction away from a printing medium,
wherein said print wire driving circuit drives said print wire against the biasing of said biasing member with a current sufficient to prevent said print wire from snapping back due to the biasing of said biasing member when said print wire contacts the printing medium.

20. The printing device according claim 1, wherein said printing device is an impact printer.

21. A method of setting a print gap for a printing device, comprising:
driving a print wire attached to a print wire armature when said print wire is spaced from a printing medium;
moving said print wire toward said printing medium;
using a Hall sensor, sensing a magnetic flux in the vicinity of a variable air gap associated with said driven print wire; and
setting the print gap based on a signal generated when the magnetic flux sensed by said Hall sensor in the vicinity of the variable gap exceeds a predetermined value.

22. The method according to claim 21, wherein the print gap is set by moving a print head of said printing device a predetermined distance from the position of said print head at the time when the magnetic flux sensed by the Hall sensor exceeds the predetermined value.

23. The method according to claim 22, wherein the driven print wire is in contact with a first end of said print wire armature and said print wire armature is arranged to pivot around a first pole end of a yoke, the variable air gap being an air gap between a second end of said print wire armature and a second pole end of said yoke.

24. The method according to claim 21, wherein said printing device is an impact printer.

25. A method for setting a print gap between a print head of a printing device and a printing medium, comprising:
automatically determining a compressibility of the printing medium; and
setting the print gap based on the determined compressibility.

26. The method according to claim 25, wherein the compressibility is automatically determined using a magnetic field sensor.

27. The method according to claim 26, wherein the magnetic field sensor comprises a Hall sensor.

28. The method according to claim 25, wherein said printing device is an impact printer.

29. A method for setting a current for driving a print wire in a printing device, comprising:
determining a compressibility of a printing medium on which the print wire prints; and
setting the current for driving the print wire during printing operations based on the determined compressibility.

30. The method according to claim 29, wherein the compressibility is automatically determined using a magnetic field sensor.

31. The method according to claim 30, wherein the magnetic field sensor comprises a Hall sensor.

32. The method according to claim 29, wherein said printing device is an impact printer.
